(19) United States
(12) Patent Application Publication
(10) Pub. No.: US 2025/0156790 A1
(43) Pub. Date: May 15, 2025

(54) CROSS-REGION DATA COLLECTION AND REPORTING SYSTEM FOR MULTINATIONAL ORGANIZATIONS

(71) Applicant: Microsoft Technology Licensing, LLC

(72) Inventors: Jose Araujo BARRETO, Redmond, WA (US); Uday Kumar PASUMARTHY, Snohomish, WA (US); Lavanya Paravastu PATTARABHIRAN, Seattle, WA (US); Lohith Sritej MADHALA, Vancouver (CA); Lukas Levon MISSIK, Seattle, WA (US); Zheng ZHAO, Bellevue, WA (US); Kai Yiu LUK, Seattle, WA (US)

(73) Assignee: Microsoft Technology Licensing, LLC, (omitted)

(21) Appl. No.: 18/506,577

(22) Filed: Nov. 10, 2023

(51) Int. Cl. G06Q 10/0639

(52) U.S. Cl. CPC G06Q 10/0639

(57) ABSTRACT

A data collection and reporting system for a multinational corporation (MNC) identifies the regions with which the MNC is associated and generates region data collecting jobs to be executed in each of these regions. The jobs are executed during off-peak hours for each region. Each region data collecting job results in a region aggregate to be computed based on the data collected from the region. Once all region aggregates have been computed and stored, a global aggregate is computed from the region aggregates. The global aggregate is then processed to generate reporting data which is used to generate one or more data reports for the MNC.

### BACKGROUND

Businesses and organizations require large amounts of data to be collected and processed in order to gain insights into performance, identify trends, and create strategies for improvement. However, to satisfy data sovereignty requirements, organizations have been required to establish local data centers and infrastructure for storing and processing data in some of the geographic regions in which their data resides. Having data distributed across multiple geographic regions can make data collection and reporting more difficult for businesses and organizations that operate in multiple regions (referred to herein collectively as “multinational corporations”, or MNCs). Data collection has typically been performed at report time. However, due to variations in peak and off-peak times among different geographic regions, running a report during off-peak hours in one region can result in data collection during peak hours in another region. As a result, data collection is oftentimes slow and inefficient. In addition, data sovereignty requirements can impose restrictions on when, how, and what types of data can be accessed from outside of a geographic region. This can interfere with an MNCs ability to gain insights into global operations and performance.

Hence what is needed is a fast and efficient means of collecting and aggregating cross-region data for MNCs that addresses the limitations of the prior art.

### SUMMARY

In one general aspect, the instant disclosure presents a data collection and aggregation system having a processor and a memory in communication with the processor wherein the memory stores executable instructions that, when executed by the processor alone or in combination with other processors, cause the data collection and aggregation system to perform multiple functions. The function may include identifying a plurality of regions associated with a multinational corporation (MNC) for which a data report is to be generated; generating a region data collecting timer job for each of the identified regions, each region data collecting job being programmed to collect predefined data within one of the identified regions; triggering execution of each region data collecting job during off-peak hours of the region in which the region data collecting job is being executed; causing the region data collecting job for each of the identified regions to compute a region aggregate for the region associated with the region data collecting job using data collected from the associated region; once the region aggregates for the identified regions have been computed, computing a global aggregate based on the region aggregates using a data collection component; processing the global aggregate to generate reporting data using a data processing component; and generating one or more reports based on the reporting data using a report generating component.

In yet another general aspect, the instant disclosure presents a method for collecting and aggregating cross-region data for a multinational corporation (MNC). The method includes identifying a plurality of regions associated with the MNC; generating a region data collecting timer job for each of the identified regions, each region data collecting job being programmed to collect predefined data within one of the identified regions; triggering execution of each region data collecting job during off-peak hours of the region in which the region data collecting job is being executed; causing the region data collecting job for each of the identified regions to compute a region aggregate for the region associated with the region data collecting job using data collected from the associated region; after region aggregates have been computed for all of the identified regions, using a data collection component to compute a global aggregate based on the region aggregates; processing the global aggregate to generate reporting data using a data processing component; and generating one or more reports based on the reporting data using a reporting generating component.

In a further general aspect, the instant application describes a non-transitory computer readable medium on which are stored instructions that when executed cause a programmable device to perform functions of identifying a plurality of regions associated with a multinational corporation (MNC); generating a region data collecting job for each of the identified regions, each region data collecting job being programmed to collect predefined data within one of the identified regions; triggering execution of each region data collecting job during off-peak hours of the region in which the region data collecting job is being executed; causing the region data collecting job for each of the identified regions to compute a region aggregate for the region associated with the region data collecting job using data collected from the associated region; once region aggregates have been computed for all of the identified regions, using a data collection component to compute a global aggregate based on the region aggregates; processing the global aggregate to generate reporting data using a data processing component; and generating one or more reports based on the reporting data using a report generating component.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein may be implemented.

FIG. 2 depicts an example of how data for MNCs can be spread across multiple regions.

FIG. 3 shows an example implementation of a data collection and reporting system that is used in the computing environment of FIG. 1.

FIG. 4 is a diagram showing how cross-region data collection is performed using region data collection jobs and how aggregated data is handled by the system.

FIG. 5 shows a flowchart of an example method for collecting and aggregating cross-region data for an MNC.

FIG. 6 is a block diagram showing an example software architecture, various portions of which may be used in conjunction with various hardware architectures herein described, which may implement any of the described features.

FIG. 7 is a block diagram showing components of an example machine configured to read instructions from a machine-readable medium and perform any of the features described herein.

### DETAILED DESCRIPTION

Traditionally, businesses rely on the interpretation of large amounts of data to gauge performance, identify trends, create strategies, and guide decision-making. In fast-paced business environments, timely decision-making is crucial. Fast and efficient data collection, therefore, is paramount to enable businesses to make informed decisions, adapt to changes, and seize opportunities as they occur. However, data sovereignty requirements can pose challenges to a business's ability to quickly and efficiently gather data. Data sovereignty refers to country, state, or region-specific regulations requiring that data created or collected within certain defined geographic boundaries stay within those boundaries. These regulations are being enacted to protect personal and organizational data, to maintain control over data that may have national or regional security implications, and/or to address other national or regional issues.

To satisfy data sovereignty requirements, businesses typically must establish local data centers and infrastructure in the geographic region in which their data resides. Businesses and organizations operating in multiple countries or geographic regions (referred to herein collectively as “multinational corporations,” or MNCs) therefore often have data distributed across multiple geographic regions. However, gathering data from multiple regions at report time can be slow and inefficient. For example, different regions may have different peak hours, so running a report during off-peak hours in a home region can result in data being collected during peak hours in other regions which can greatly slow the data gathering process.

To address these technical problems and more, in an example, this description provides technical solutions in the form of a data collection and reporting system that enables cross-region data collection for MNCs to be performed automatically and in a fast and efficient manner. This is enabled through the use of predefined region data collection jobs which are used to collect and aggregate data from each region. Once data aggregates have been generated for each region, the data collection system computes a global data aggregate from the region data aggregates. As used herein, the term “aggregate” with respect to data refers to a collection, compilation, summary, or the like of data from multiple sources that has been processed and expressed in a form that facilitates cross-region aggregation, analysis, and reporting. Data aggregation may also include the removal of certain types of data, such as personal data (e.g., personal identifiable information (PII)), sensitive and confidential individual and organizational data, financial information, and the like. Any suitable data aggregation process can be used to generate aggregate data from raw data collected from each region. A region data aggregate or region aggregate refers to a compilation of data that has been collected from a region and processed into a summary form for reporting. Similarly, a global aggregate refers to an aggregation of region aggregates that has been processed into a summary form for reporting.

Region data collection jobs are generated, respectively, for each separate region associated with an MNC for collecting raw data from within each region and computing a region aggregate of the raw region data. Region data collecting jobs are scheduled to be performed according to a predefined schedule and/or interval, e.g., daily, weekly, monthly, on a certain day or days of a week, during a certain week or weeks of a month, etc. Region data collecting jobs are each scheduled to be performed during off-peak hours for each respective region. This has the technical advantage of minimizing network bandwidth and computation resources required for cross-region data collection relative to the bandwidth and computation resources typically required for global data collection operations.

In this way, a data aggregate from each region associated with an MNC is collected. The region data aggregate from each region is stored in local data store, which can be any suitable type of data storage or memory system that is physically located within each respective region. The data collection system waits for all region aggregates to be completed and stored before accessing the region aggregates to calculate a global aggregate for the MNC. In various implementations, the region data aggregate from each region is copied to a global data store, which is a data storage or memory system that is physically located within a primary region (also referred to as a main region or home region) for an MNC. The data collection system accesses the region data aggregates stored in the global data store. One or more reports may then be generated based on the global data aggregate and/or the region data aggregates. Reports can be used to organize and present numerical business data in a way that communicates meaningful information to viewers. Reports can also include visualizations of data, such as charts, graphs, and maps, that show relationships among represented data.

In various implementations, the data collection and reporting system is configured to determine the regions associated with each MNC that interact with the system and to determine all the data sites within each region from which data may be collected. Region and site data can be determined in any suitable manner. In some implementations, region data for MNCs is collected as part of an initial setup routine and/or an update routine during which an administrator user for an MNC can input/designate a primary region and one or more secondary regions for the MNC. In various implementations, MNCs can select one or more sites with a region for handling data. Alternatively, site information per MNC can be tracked internally within the system as data is processed and stored within a region.

Data collection within each region can be performed in any suitable manner. In some implementations, data collection can be performed by communicating with one or more reporting servers which have been implemented within a region. In other implementations, local data collection can include generating queries, such as structured language queries (SQL), for obtaining desired data from databases within a region. Once the data has been collected from within a region, a region data aggregate is calculated for the region.

In some implementations, data is collected from each region on a site-by-site basis. As used herein, the term “site” refers to a partition, or slice, of data that exists in a region. As an example, in some implementations, site data collection jobs are generated and used to collect and aggregate MNC data from each site. The site data and/or the site data aggregate collected from a site can be stored in a suitable memory and/or data store at the site. The aggregated data from each site within a region can be copied to and/or stored in a region data store which is located at a predesignated main or primary site for an MNC within a region.

The data collection system can also be used to collect and aggregate information from multiple regions associated with an MNC, even when data sovereignty restrictions for one or more regions prevent direct access to data from outside of a region. For example, the data collection system enables insight information to be collected and aggregated from each region associated with an MNC by accessing only the metadata associated with data within each region. The metadata associated with files, documents, messages, emails, storage, and the like can provide insight into a number of different aspects of an organization without requiring access to the actual data. For example, metadata can be used to determine how the people associated with an organization collaborate and communicate within the organization and outside the organization. Cross-region metadata can be collected in substantially the same manner as described above with regard to actual data.

Metadata can be used to identify collaboration events, such the use of attachments in email, sharing of online files, accessing shared files, creating files in organization storage, and the like. Collaboration events can be identified and processed to provide insight into how people and/or groups within an organization collaborate and the extent to which collaboration occurs. For example, metadata can be used to determine how many people share files as an email attachment, how many people who have access to organizational storage actually create files, percentage of people that share content externally, and the like. Similarly, metadata can be used to gain insight into how people within an organization communicate, such as percentages of people who use different communication methods, such as email, messages, posts, etc., and how people meet within an organization (e.g., frequency, numbers of participants, in-person or virtual, etc.).

The technical solutions described herein address the technical problem associated with previously known cross-region data collection methods by separating data aggregation into region and global operations. Region data aggregation can be performed automatically at off-peak hours for each region and be repeated on a regular basis to maintain a fresh aggregate of the local data for each region. Generating global data reports for MNCs therefore does not require cross-region data collection to occur at report time. Global data aggregation can also be performed during off-peak hours for the primary region, or other region, in which the global aggregation takes place. Global data aggregation can be performed on a regular basis and at predetermined intervals so that a fresh version of the global data aggregate for an MNC is maintained and updated as frequently as desired by the MNC. In this way, data collection for reporting purposes does not have to occur at report time. Because data collection operations do not have to be performed at report time and because updated global and local data aggregates are maintained and made available at all times, the time needed to generate reports on global data is reduced while also increasing the efficiency of generating such reports. This also provides the technical advantage of reducing network bandwidth and computation resources that may otherwise be required when data collection occurs at report time.

The technical solutions described herein also enable cross-region information for an MNC to be collected in situations in which data sovereignty rules prevent the direct access of data, such as personal and sensitive data pertaining to individuals and organizations, from outside of the region in which the data is located. In this case, the system can be used to collect and aggregate metadata associated with the files, documents, emails, messages, storage locations, and the like. This information can be used to gain insight into how the individuals within an organization collaborate, communicate, meet, and the like.

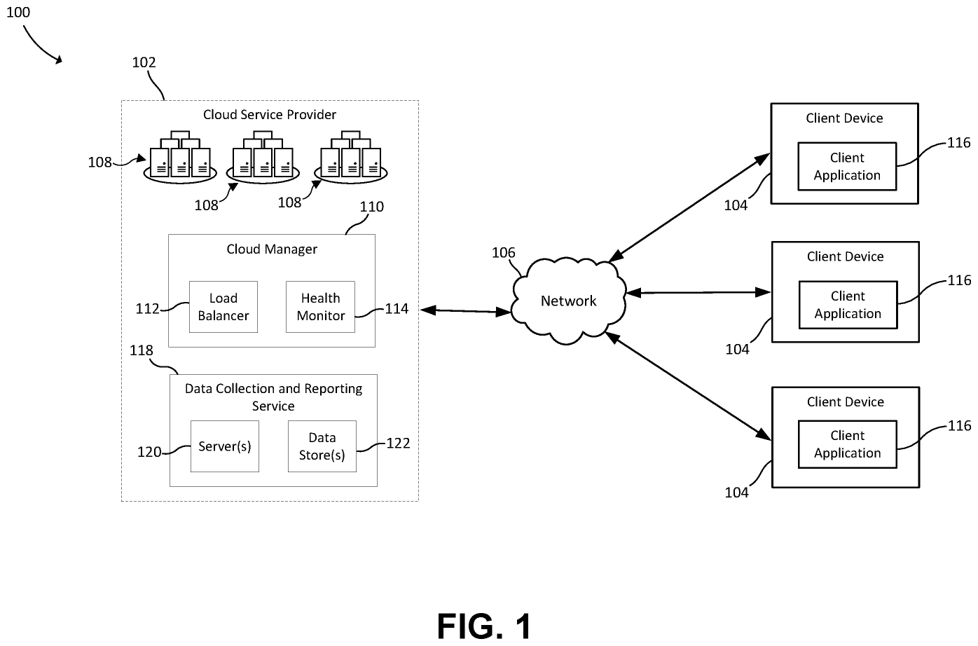

FIG. 1 is a diagram showing an example computing environment 100 in which aspects of the disclosure may be implemented. Computing environment 100 includes a cloud service provider 102, client devices 104, and a network 106. The network 106 includes one or more wired and/or wireless networks. In embodiments, the network 106 includes one or more local area networks (LAN), wide area networks (WAN) (e.g., the Internet), public networks, private networks, virtual networks, mesh networks, peer-to-peer networks, and/or other interconnected data paths across which multiple devices may communicate.

The cloud service provider 102 is configured to offer cloud-based platforms, infrastructures, applications, and/or storage services to customers. The cloud service provider 102 includes data centers 108 which house the physical components, such as servers, network devices, storage elements and other devices, for implementing the services provided to customers. Three data centers 108 are shown in the example of FIG. 1 although any suitable number of data centers may be utilized. Cloud service provider 102 includes a cloud manager 110 for managing various aspects of the cloud services provided to customers. Cloud manager 110 includes a load balancer 112 for distributing requests and workloads among servers. Cloud manager 110 also includes a health monitor 114 for monitoring the health of physical and virtual resources and identifying faulty components so that remedial action can be taken.

The cloud service provider 102 also provides a data collection and reporting service 118 to clients. The data collection and reporting service 118 provides data collection, data analytics, and report generating functionality. Cloud service provider 102 includes one or more servers 120 which provide computational and storage resources for the data collection and reporting service 118. Servers 120 are implemented using any suitable number and type of physical and/or virtual computing resources (e.g., standalone computing devices, blade servers, virtual machines, etc.). Cloud service provider 102 also includes one or more data stores 122 for storing data, programs, and the like for implementing and managing the data collection and reporting service. In FIG. 1, one server 120 and one data store 122 are shown, although any suitable number of servers and/or data stores may be utilized for the data collection and reporting service.

Client devices 104 enable users to access the services provided by the cloud service provider 102 via the network 106. Client devices 104 can be any suitable type of computing device, such as personal computers, desktop computers, laptop computers, smart phones, tablets, gaming consoles, smart televisions and the like. Client devices 104 include one or more client (software) applications that are configured to interact with services made available by cloud service provider 102. For example, client devices 104 include client applications 116 which enable users to interact with the data collection and reporting service 118. In some implementations, client application 116 is implemented as a stand-alone application that is installed on the client and which is capable of interacting with the data collection and reporting service. In other implementations, client application 116 is a general-purpose application, such as a web browser, which can be used to access a web application for interacting with the data collection and reporting service.

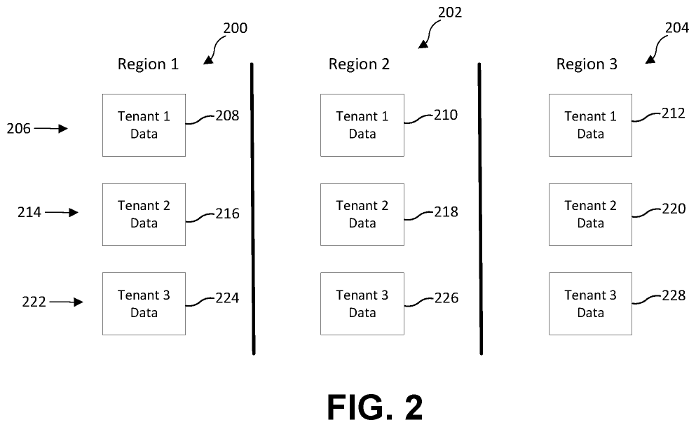

As mentioned above, a cloud service provider can include multiple data centers. These data centers can be spread across multiple geographic regions (e.g., United States, Europe, China, and the like). As a result, an MNC can have data on premises (e.g., located in one or more data centers) in more than one of the geographic regions. This is typically done to satisfy data sovereignty requirements of different regions. FIG. 2 shows an example of how data for MNC tenants can be distributed across multiple geographic regions. In FIG. 2, three different regions 200, 202, 204 are shown. A first MNC tenant 206 has data 208 in one or more sites in the first region 200, data 210 in one or more sites in the second region 202, and data 212 in one or more sites in the third region 204. A second MNC tenant 214 has data 216 in one or more sites in the first region 200, data 218 in one or more sites in the second region 202, and data 220 in one or more sites in the third region 204. A third MNC tenant 222 has data 224 in one or more sites in the first region 200, data 226 in one or more sites in the second region 202, and data 228 in one or more sites in the third region 204. As part of a setup process, MNC tenants can define the regions in which their data will be stored and select one of these regions as a primary or home region for the MNC.

Previously known data collection systems typically collected cross-region data at report time (e.g., when a report is requested or scheduled to be generated), depending on data sovereignty requirements of the regions. A global aggregate of the data was then calculated from the cross-region data that was collected. This method of collecting and aggregating data can be slow, inefficient, and unpredictable for various reasons, such as different peak and off-peak hours for different regions, which can result in widely varying data collecting times across regions. The data collection and reporting system according to the instant disclosure enables cross-region data collection for MNCs to be performed automatically and in a fast and efficient manner through the use of predefined data collection jobs which can collect and calculate local data aggregates for each region, respectively, and according to a predetermined schedule or interval such that data collection is performed during off-peak hours in each region. Local data aggregation is completed for each region first. The local data aggregates from each region are then used to calculate a global data aggregate.

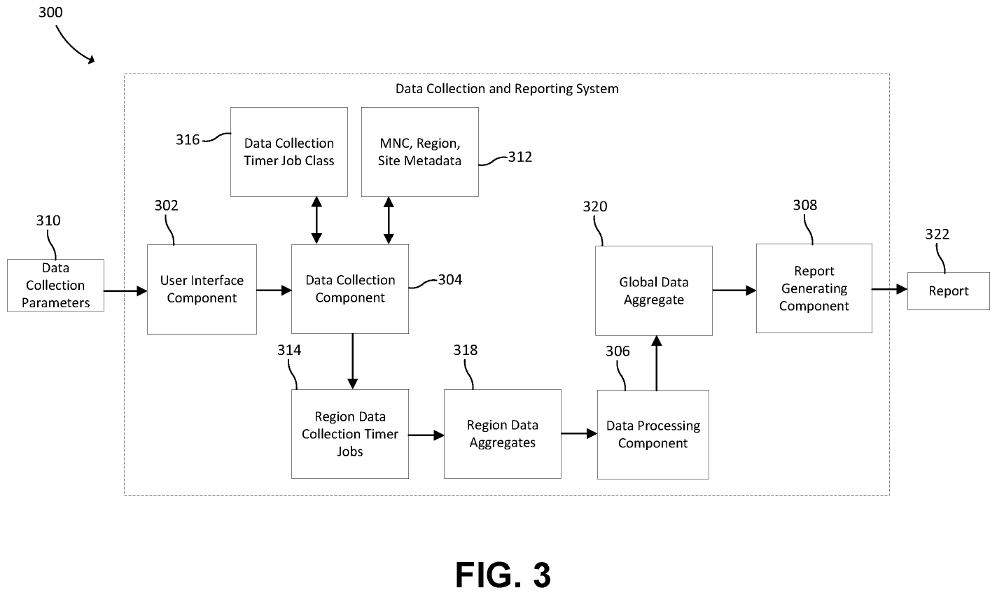

An example implementation of a data collection and reporting system 300 is shown in FIG. 3. Data collection and reporting system 300 includes a user interface component 302, a data collection component 304, a data processing component 306, and a report generating component 308. The use interface component 302 is configured to receive data collection parameters 310, such as entity requesting report/data collection, data type to collect, report type to generate, visualization to generate, and/or report schedule (e.g., daily, weekly, monthly, etc.). Data collection parameters can be received via a user entering/selecting parameters via the user interface and/or can be received via report definition file which defines the data type(s), analytics, and/or scheduling for one or more types of reports. Data collection component 304 receives the data collection parameters 310 and accesses MNC, region, and site metadata 312 which is maintained by the system to determine the regions associated with the MNC requesting a report/data collection. The metadata may also indicate the sites within each region which are associated with the MNC, as well as peak and/or off-peak hours associated with each region and/or site.

The data collection component 304 receives the data collection parameters 310 and the MNC, region, and site metadata 312 and is configured to orchestrate data collection in accordance with the parameters and metadata. In various implementations, data collection component 304 is configured to generate data collection timer jobs 314 for collecting data within each region associated with the MNC. As is known in the art, a “timer job” is a job configured to perform a predefined process according to a predefined schedule. In this case, the cloud-service provider incudes mechanisms for flighting timer jobs to each region and triggering timer jobs within each region according to their defined schedules. In various implementations, regional data collection timer jobs 314 are generated based on a predefined timer job class 316. The timer job class 316 includes programmed instructions, scripts, configuration data, and the like for implementing data collection operations, interacting with data storage and reporting components within data centers, and calculating data aggregates from collected data.

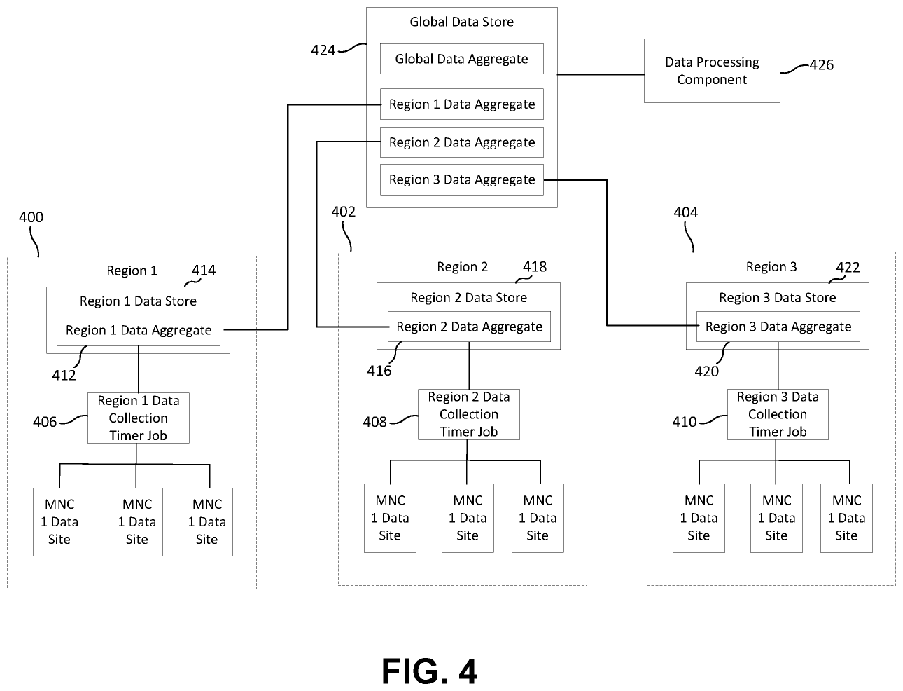

Referring to FIG. 4, a region data collection timer job is generated for each region associated with an MNC. In the example of FIG. 4, the MNC is associated with three regions 400, 402, 404. A region data collection timer job 406, 408, 410 is generated to collect data from relevant sites within each of the three regions 400, 402, 404, respectively. Once the data within a region is collected, the region data collection timer job computes a region aggregate for the data within the region and stores the region aggregate in a region data store. In the example of FIG. 4, the region data collection job 406 in region 400 computes a region data aggregate 412 which is stored in a region data store 414; the region data collection job 408 in region 402 computes a region data aggregate 416 which is stored in a region data store 418; and the region data collection job 410 in region 404 computes a region data aggregate 420 which is stored in a region data store 422.

The region data aggregates 412, 416, 420 from each region are also copied to a global data store 424. In some implementations, the global data store is located within a data center or site in the primary region for the MNC. Each region data collection timer jobs is programmed to wait for all relevant data to be collected within their region before calculating the region data aggregate for that region. Region data collecting jobs are triggered during off-peak hours for the region in which they are implemented. The off-peak hours for regions and sites within regions can be determined in any suitable manner, such as from the metadata associated with the regions and sites and/or from historical data pertaining to the operation of data centers within each region. This minimizes the impact of data collection on the normal operating processes within a region. It also can reduce the network bandwidth and amount of computation resources that would otherwise be required for data collection at report time and during peak hours.

A data processing component 426 for a data collection and reporting system waits for each of region data collection timer jobs and the region aggregates from all regions to be computed and stored in the global data store 424, before accessing the region aggregates and computing a global aggregate 428. The global aggregate 428 is then stored in the global data store 424. Returning to FIG. 3, the data processing component 306 performs a data aggregation process on the region aggregates to generate a global aggregate 320. The report generating component 308 is configured to generate one or more reports 322 based on the global aggregate 320 which can be provided to the user interface component and displayed for viewing by users of the system. Reports can be generated in any suitable manner known in the art. Reports can be used to organize and present numerical business data in a way that communicates meaningful information to viewers. Reports can also include visualizations of data, such as charts, graphs, and maps, that show relationships among represented data. In various implementations, region data aggregates 318 can also be provided to the data processing component 306 to generate regional reporting data which can be used as the basis for generating regional reports.

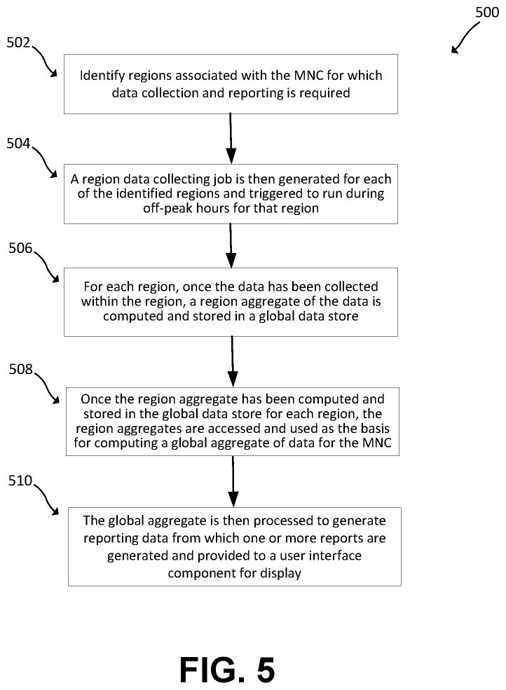

Referring now to FIG. 5, a flowchart of an example method 500 of collecting and aggregating cross-region data for an MNC is shown. The method begins with identifying the regions associated in which the MNC has data to be collected (block 502). The regions can be identified in any suitable manner. As an example, the regions associated with an MNC can be identified by accessing metadata associated with the MNC, which lists the regions associated with the MNC. Region data collecting jobs are then generated for each region associated with the MNC and triggered to run during off-peak hours for the regions (block 504). Region data collection can be performed in any suitable manner, such as by interacting with one or more reporting servers and/or accessing data stores directly to collect data. When the data within a region has been collected, a region aggregate of the data is computed and stored in a global data store (block 506). In various implementations, the region aggregate is stored first in a region data store before being copied to the global data store for global data aggregation. Once the region aggregate has been computed for each region and stored in the global data store, the region aggregates are accessed and used as the basis for computing a global aggregate of the data for the MNC (block 508). The global aggregate is then processed to generate reporting data from which one or more reports are generated and provided to a user interface component for display (block 510). The report can include various numerical and/or visual representations of global data from which various information pertaining to the MNC can be derived.

As noted above, the data collection system can be used to collect and aggregate information from multiple regions associated with an MNC even when data sovereignty restrictions for one or more regions prevent direct access to data from outside of a region. For example, the data collection system enables metadata to be collected and aggregated from each region associated with an MNC. The metadata associated with files, documents, messages, emails, storage, and the like data can provide insight into a number of different aspects of an organization without requiring access to the actual data. Region data collecting jobs can be generated for collecting metadata in each region associated with an MNC, and a region metadata aggregate can be computed for each region. The region metadata aggregates can then be used to calculate a global metadata aggregate for the MNC. The global metadata aggregate can be processed to identify collaboration events, communication events, meeting events, and the like which in turn can be used to gain insights into how an organization and the people within an organization interact with each other and with the various productivity tools for which the they have access.

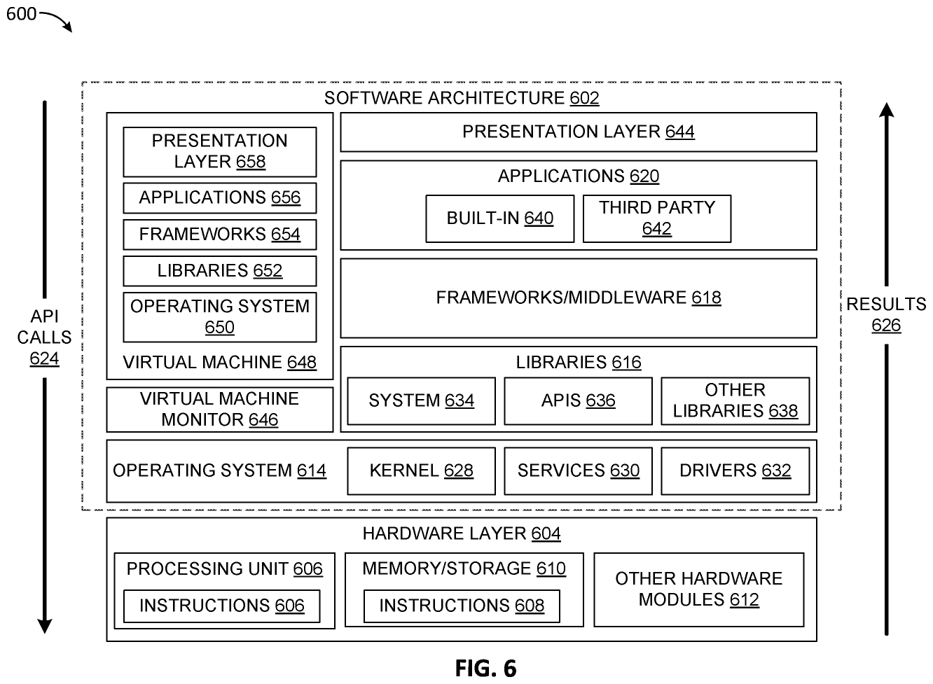

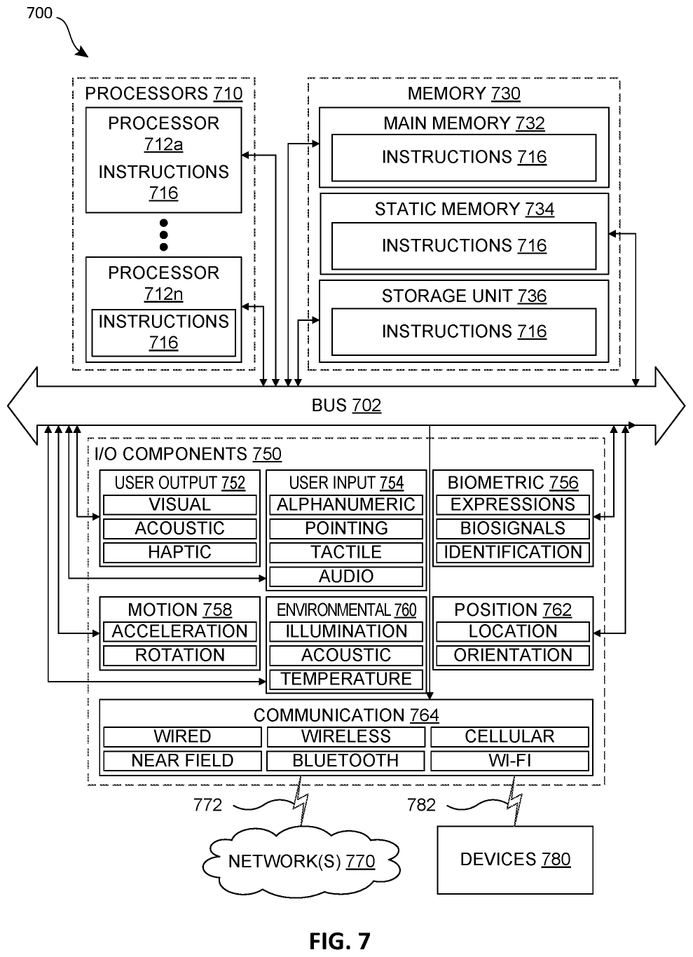

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment.

Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data collection and aggregation system comprising:
a processor; and
a memory in communication with the processor, the memory comprising executable instructions that, when executed by the processor alone or in combination with other processors, cause the data collection and aggregation system to perform functions of:
identifying a plurality of regions associated with a multinational corporation (MNC) for which a data report is to be generated;
generating a region data collecting timer job for each of the identified regions, each region data collecting job being programmed to collect predefined data within one of the identified regions;
triggering execution of each region data collecting job during off-peak hours of the region in which the region data collecting job is being executed;
causing the region data collecting job for each of the identified regions to compute a region aggregate for the region associated with the region data collecting job using data collected from the associated region;
once the region aggregates for the identified regions have been computed, computing a global aggregate based on the region aggregates using a data collection component;
processing the global aggregate to generate reporting data using a data processing component; and
generating one or more reports based on the reporting data using a report generating component.

2. The data collection and aggregation system of claim 1, wherein each of the region aggregate is stored in a region data store located in the region associated with the region aggregate.

3. The data collection and aggregation system of claim 2, wherein each of the region aggregates is stored in a global data store for the data collection and reporting system, the global data store being located within a primary region of the MNC.

4. The data collection and aggregation system of claim 1, wherein the predefined data corresponds to metadata for at least one of files, documents, emails, messages, and storage within each of the respective regions.

5. The data collection and aggregation system of claim 4, wherein the region aggregates each correspond to a region metadata aggregate and the global aggregate corresponds to a global metadata aggregate.

6. The data collection and aggregation system of claim 5, wherein processing the global aggregate to generate reporting data further comprises:
processing the global metadata aggregate to identify collaboration events and generating reporting data based on the identified collaboration events.

7. The data collection and aggregation system of claim 6, wherein the collaboration events include at least one of sharing files as email attachments, sharing online files, creating files in organizational storage, and having shared access to online files.

8. The data collection and aggregation system of claim 1, wherein data associated with the MNC within at least one of the regions is further partitioned into a plurality of sites.

9. A method for collecting and aggregating cross-region data for a multinational corporation (MNC), the method comprising:
identifying a plurality of regions associated with the MNC;
generating a region data collecting timer job for each of the identified regions, each region data collecting job being programmed to collect predefined data within one of the identified regions;
triggering execution of each region data collecting job during off-peak hours of the region in which the region data collecting job is being executed;
causing the region data collecting job for each of the identified regions to compute a region aggregate for the region associated with the region data collecting job using data collected from the associated region;
after region aggregates have been computed for all of the identified regions, using a data collection component to compute a global aggregate based on the region aggregates;
processing the global aggregate to generate reporting data using a data processing component; and
generating one or more reports based on the reporting data using a reporting generating component.

10. The method of claim 9, wherein each of the region aggregate is stored in a region data store located in the region associated with the region aggregate.

11. The method of claim 10, wherein each of the region aggregates is copied from the region data store associated with the region aggregate to a global data store for the data collection and reporting system, the global data store being located within a primary region of the MNC.

12. The method of claim 9, wherein the predefined data corresponds to metadata for files, documents, emails, messages, and storage within each of the respective regions.

13. The method of claim 12, wherein the region aggregates each correspond to a region metadata aggregate and the global aggregate corresponds to a global metadata aggregate.

14. The method of claim 13, wherein processing the global aggregate to generate reporting data further comprises:
processing the global metadata aggregate to identify collaboration events and generating reporting data based on the identified collaboration events.

15. The method of claim 14, wherein the collaboration events include sharing files as email attachments, sharing online files, creating files in organizational storage, and having shared access to online files.

16. The method of claim 9, wherein data associated with the MNC within at least one of the regions is further partitioned into a plurality of sites.

17. A non-transitory computer readable medium on which are stored instructions that, when executed, cause a programmable device to perform functions of:
identifying a plurality of regions associated with a multinational corporation (MNC);
generating a region data collecting job for each of the identified regions, each region data collecting job being programmed to collect predefined data within one of the identified regions;
triggering execution of each region data collecting job during off-peak hours of the region in which the region data collecting job is being executed;
causing the region data collecting job for each of the identified regions to compute a region aggregate for the region associated with the region data collecting job using data collected from the associated region;
once region aggregates have been computed for all of the identified regions, using a data collection component to compute a global aggregate based on the region aggregates;
processing the global aggregate to generate reporting data using a data processing component; and
generating one or more reports based on the reporting data using a report generating component.

18. The non-transitory computer readable medium of claim 17, wherein the predefined data corresponds to metadata for files, documents, emails, messages, and storage within each of the respective regions.

19. The non-transitory computer readable medium of claim 18, wherein the region aggregates each correspond to a region metadata aggregate and the global aggregate corresponds to a global metadata aggregate.

20. The non-transitory computer readable medium of claim 19, wherein processing the global aggregate to generate reporting data further comprises:
processing the global metadata aggregate to identify collaboration events and generating reporting data based on the identified collaboration events.
